(19) United States
(12) Patent Application Publication
(10) Pub. No.: US 2024/0159513 A1
(43) Pub. Date: May 16, 2024

(54) MEASURING DEVICE AND METHOD FOR MEASURING OPTICAL ELEMENTS

(71) Applicant: Dutch United Instruments B.V., ENSCHEDE (NL)

(72) Inventors: Rens HENSELMANS, ENSCHEDE (NL); Gerard Cornelis VAN DEN EIJKEL, ENSCHEDE (NL)

(73) Assignee: Dutch United Instruments B.V., ENSCHEDE (NL)

(21) Appl. No.: 18/280,072

(22) PCT Filed: Mar. 3, 2022
(86) PCT No.: PCT/NL2022/050119

§ 371 Date: Sep. 1, 2023

(30) Foreign Application Priority Data
Mar. 5, 2021 (NL) 2027713

(51) Int. Cl. G01B 11/00; G01M 11/02

(52) U.S. Cl. CPC G01B 11/002; G01M 11/0214; G01M 11/025

(57) ABSTRACT

A measurement device for determining one or more parameters indicative of the relative position of a first surface of an optical element with respect to a second surface of an optical element. The measurement device includes a supporting device having a supporting surface for supporting the optical element in a first direction. The supporting surface is arranged for abutting one of the first and second surfaces. A measurement unit is arranged for mapping a geometry of the other of the first and second surfaces and for mapping a geometry of the supporting surface of the supporting device by taking measurements of the respective surfaces. A processing unit determines the one or more parameters on the basis of a provided geometry of the one of the first and second surfaces, the mapped geometry of the other of the first and second surfaces and the mapped geometry of the supporting surface.

The invention relates to a measurement device, and method, for determining one or more parameters being indicative for the relative position of a first surface of an optical element with respect to a second surface of an optical element.

Precision optical elements, such as high-performance lenses or mirrors, are used in different high-tech applications. One of these applications are for instance lithography systems used for the production of semiconductors. Such a semiconductor lithography system undertakes a process whereby complex circuit patterns, which are drawn on a photomask made of a large glass plate, are reduced using the high-performance lenses and exposed onto a silicon substrate that is commonly known as a wafer.

The level of detail attainable, i.e. the accuracy and resolution, of this process is determined, among others, by the quality of the high-performance lenses used in the lithography system. In addition, the lenses and mirror surfaces used in these systems do not only comprise traditional spherical surfaces, but also aspherical (or freeform) surfaces. In the production of these precision optical elements it is therefore important to be able to measure the specifications and dimensions of the different optical elements obtained, such that the quality of the optical elements can be achieved and verified.

Although single, isolated, surfaces can be measured with a high resolution and accuracy using existing optical probe measurement systems, it is often difficult, or even practically impossible, to accurately measure the surfaces on both sides of a lens with respect to each other. Measuring the second side typically requires flipping the optical device in the measurement device, such that the other surface is facing the optical probe such that measurement can be taken. Due to flipping the optical element, a reference correlating the already measured surface with the measurement device is lost or cannot be accurately retained, such that one is not able to directly measure the second surface with respect the first surface. However, as the optical properties of the lens are not only dependent on the individual surfaces, but also on the relative positioning of these surfaces with respect to each other, this further adds to the complexity of verifying the quality of these optical elements.

In for instance WO 2015/0176805, a solution is proposed to solve this problem is to provide a reference ring having front and back surfaces comprising reference marks for correlating the front and back surfaces of the reference ring. This reference ring is clamped around lens and used to correlate the measurements of the surfaces on both sides of the lens. These rings, however, apply a clamping force to the lens for fixedly holding the lens, such that small, but significant, deformations can be introduced in the lens to be measured, thereby negatively influencing the accuracy of the overall measurement. In addition, these rings require customization to match the lens to be measured, which adds to the costs and time involved for taking measurements. These rings are also less suited for measuring freeform optical elements, which could comprise aspherical surfaces and/or a non-cylindrical circumferential edge.

It is a goal of the current invention, next to other goals, to provide for a measurement system, and method, that is able to determine one or more parameters being indicative for the relative position of a first surface of an optical element with respect to a second surface of an optical element, wherein at least one of the above-mentioned problems is at least partially alleviated.

In a first aspect, the invention relates to a measurement device for determining one or more parameters being indicative for the relative position of a first surface of an object, in particular an optical element, such as a lens or mirror, a window or wafer, with respect to a second surface of the object, the measurement device comprising:
a supporting device comprising a supporting surface for supporting the object in the measurement device in a first direction, wherein said supporting surface is arranged for abutting one of the first and second surfaces of the object;
a measurement unit arranged for mapping a geometry of the other of the first and second surfaces of the object and for mapping a geometry of the supporting surface of the supporting device by taking measurements of the respective surfaces;
a processing unit that is configured to determine the one or more parameters on the basis of a provided geometry of the one of the first and second surfaces, the mapped geometry of the other of the first and second surfaces and the mapped geometry of the supporting surface.

The geometry of the surface may refer to a surface shape, in particular a three dimensional surface shape, of the respective surface the object, e.g. an optical element, such as a lens or mirror, window or wafer. Such a geometry may for instance be provided, and/or obtained through measurements, as: a three dimensional point cloud representing the surface; a meshed surface shape; an interpolated surface shape, wherein the geometry is defined as a parametric model by means of any suitable interpolation method, such as linear, (bi)cubic or spline interpolation methods, Inverse Distance Weighted (IDW) interpolation, Kriging interpolation and the like.

The process of mapping a surface can comprise scanning the respective surface along a scanning path, of for instance adjacent and/or consecutive lines, that runs over (i.e. along), at least a part, of the respective surface, by enabling a relative movement of the respective surface and a measurement head along at least a direction substantially parallel to (a tangent plane of) the respective surface, comprising for instance a probing instrument, an optical probe and/or any instrument suitable for determining a (relative) position of the point measured, such that a plurality of measurement points are taken along the path. This can result, as seen in a tangent plane of the respective surface, in a spatial array (i.e. a two dimensional grid) of measurement points having their respective three dimensional coordinates. It is noted that, in order to accurately map a three dimensional surface shape, such a grid can have multiple rows (i.e. preferably more than 3, more preferably more than 6) and columns (i e preferably more than 3, more preferably more than 6) with measurement points (e.g. three dimensional coordinates).

The use of such a measurement device allows flipping, i.e. turning over, the optical element such that the other surface faces the measurement unit, while still enabling to correlate the mapped geometry of the first surface with the mapped geometry of the second surface, and while simultaneous measurements on both sides of the optical element are not required for being to correlate the mapped geometry of the first surface with the mapped geometry of the second surface. Thereby measurements can be taken from only one side of the measurement device (with respect to the optical element), also enabling the use of only one measurement unit. It neither requires the use of a marker on the optical element in order to transform the measurements from a device fixed coordinate system to an optical element fixed coordinate system, as is explained in more detail below. For instance, and as is also explained in more details below, the first surface rests on supporting surface, in particular on three fixed points on the supporting surface and/or a number of flexible points of the supporting surface, such that the position of the optical element is sufficiently determined with respect to the supporting surface. Due to the fact that both the supporting surface and the first surface are known, the correlation between the supporting surface and the first surface is also sufficiently known. By now mapping the second surface, using the measurement unit, the second surface can be correlated to the supporting surface and thereby to the first surface, which can be done by the respective processing unit, as is explained in more detail below.

It is noted that the respective device may also be suitable for determining one or more parameters being indicative for the relative position of a first surface of a general three dimensional object with respect to a second surface of the three dimensional object.

In a preferred embodiment, the provided geometry of the one of the first and second surfaces is a mapped geometry of the one of the first and second surfaces, wherein said mapped geometry is mapped by taking measurement of the one of the first and second surfaces using the measurement unit. This thus allows determining all the respective geometries using the same measurement device. The geometry of the one of the first and second surfaces can also be otherwise provided for, such as in a data set that can be loaded into, or stored in, the processing unit.

Preferably, the processing unit is arranged to define an optical element coordinate system that is fixed with respect to the optical element and to define a measurement device coordinate system that is fixed with respect to the measurement device, wherein said measurement unit is arranged for mapping the respective surfaces in the measurement device coordinate system, wherein the processing unit is arranged for determining a coordinate transformation for transforming the geometries of the first and second surfaces from the measurement device coordinate system to the optical element coordinate system, and wherein the processing unit is arranged for determining said one or more parameters on the basis of the geometries of the first and second surfaces defined in the optical element coordinate system. Hereby, it is noted that the optical element coordinate system refers to a common coordinate system from which the relative position and/or orientation of the first and second surfaces with respect to each other are known, i.e. easily determined. It is thus not required that, for instance, the optical element coordinate system finds its origin in the optical element itself.

The properties of the optical element, such as the parameters being indicative for the relative position of a first surface of the optical element with respect to a second surface of the optical element, are linked to the optical element, i.e. fixed with respect to an optical element fixed (i.e. specific) coordinate system. The measurement system is arranged for taking measurement and mapping the respective geometries in a measurement device fixed (i.e. specific) coordinate system, such that the measurement taken by the device are thus taken in the device fixed coordinate system. By transforming the measurements (i.e. mapped or provided geometries) of at least the first and second surfaces to the optical element coordinate system, the respective parameters can be determined.

By taking measurement (i.e. mapping) of the supporting surface and subsequently positioning the optical element into the supporting device such that the first surface abuts the supporting surface and measuring the second surface, the mapped supporting surface and mapped first surface are obtained in the measurement device coordinate system such that these can be correlated to each other in space. In a second step, assuming the supporting surface is not modified in the meantime, the optical element is turned over and repositioned into the supporting device such that the second surface abuts the supporting surface and the first surface is measured. Hereby, the first surface of the optical is mapped with respect to the (known) supporting surface while the (known) second surface is being supported on the (known) supporting surface. Hereby sufficient conditions are known for transforming the first and second surface to an optical element coordinate system. The origin of the optical element coordinate system can be chosen randomly on, i.e. with respect to, the optical element as the relative position of a first surface of the optical element with respect to a second surface of the optical element is not, and the parameters are thus neither, dependent on the choice of the origin.

In a preferred embodiment, the processing unit is configured to determine, based on the mapped geometry of the supporting surface and the geometry of one of the first and second surfaces of the optical element, contact points between the one of the first and second surfaces and the supporting surface, wherein said contact points correspond to locations on the one of the first and second surface where the supporting surface and the one of the first and second surface abut each other when the optical element is supported on supporting surface. These contact points between the one of the first and second surfaces and the supporting surface have already been measured or provided in the measurement device coordinate system in an earlier step. By determining the contact points of the supporting surface on the respective first or second surface, the contact points can also be obtained in the optical element coordinate system. Hereby, the respective contact points are known (in respective x, y, z-coordinates) in both coordinate systems. This enables obtaining a relation, i.e. transformation, between the respective coordinate systems.

It is therefore further preferred that said contact points are determined in the optical element coordinate system and wherein the processing unit is arranged for determining the coordinate transformation on the basis of the determined contact points. This link, or relation, allows to determine the coordinate transformation that is used for transforming the measurement results of the respective surfaces from the measurement device coordinate system, in which the measurements are taken, to the optical element coordinate system, in which the one or more parameters being indicative for the relative position of a first surface of an optical element with respect to a second surface of an optical element are determined. As the optical element will typically be supported on at least three contact points, at least six equations are obtained for solving the six independent variables of the coordinate transformation, such that an overdetermined problem is obtained that can be solved in, for instance, a least-squared approach.

In a preferred embodiment, said supporting device is arranged for supporting the optical element on one of said first and second surfaces and wherein the measurement unit is arranged for simultaneously mapping the geometry of the other of said first and second surfaces. As the optical element is supported on the supporting device, of which the supporting surface is provided, for instance by a measurement, the geometry of the other of said first and second surfaces is mapped such that it is obtained in the same measurement device coordinate system as wherein the supporting surface is provided. This allows to efficiently obtain a coordinate transformation of the respective mapped surface of the optical element to the optical element coordinate system, as is also explained above.

It is preferred that the supporting device comprises a plurality of spaced apart first supports, each comprising a contact surface for abutting the optical element, and wherein said supporting surface is formed by said contact surfaces of the plurality of first supports. By providing a plurality of spaced apart first supports, a number or discrete contact surfaces are obtained for contacting the optical element, such that the supporting surfaced is formed from the respective contact surfaces.

The plurality of (smaller) contact surfaces is thereby faster and easier to measure (i.e. map) using the measurement unit. Furthermore, a process of determining contact points is hereby also simplified, as contact can only occur at a limited number of smaller contact surfaces. Preferably, said supporting device comprises three first supports, as an object is thereby stably and uniquely supported by the supporting device. Hereby it is prevented that the object can rotate (i.e. wobble) like a four-legged table positioned on an uneven surface.

It is further preferred that at least one first support of the plurality of first supports is selectively movable with respect to the other of the plurality of first supports. Hereby, the supporting device can easily be adapted to provide a stable basis for supporting optical elements of different sizes and geometries.

In a preferred embodiment, the at least one first support comprises a reference associated with a position of the respective contact surface of the respective at least one first support, wherein the measurement unit is arranged for mapping a geometry of a reference of the at least one first support by taking measurements of the respective; and wherein the a processing unit is configured to determine the position of the respective mapped contact surface of the respective at least one first support on the basis of the mapped geometry of the respective reference. Whereas a fixed support remains substantially stationary over time, such that a mapping of its contact surface is not required for each optical element measured, the position of a movable support, and thus its contact surface, can vary over time and over different measurements. By providing a reference that is associated with the position of the contact surface, the measurement system can determine, i.e. measure, (a position and/or orientation of) the reference in order to determine, i.e. map, the position of the corresponding contact surface.

In a preferred embodiment of the measurement system, the supporting device comprises a plurality of second supports for holding the optical element in a second direction different from the first direction, wherein the second supports each comprise a contact surface for abutting a circumferential edge and/or circumferential surface of the optical element, wherein said circumferential edge and/or circumferential surface interconnects the first and second surfaces; and wherein said measurement unit is arranged for mapping the contact surface of the plurality of second supports. As the plurality of second supports are arranged to abut the circumferential edge and/or circumferential surface of the optical element at the contact surface that can be mapped by the measurement device, the circumferential edge and/or circumferential surface can be measured, at least at a number of discrete points corresponding to the contact surfaces of the second supports. This thus allows determining the first and/or second surface geometries with respect to the edge of the optical element.

It is noted that it is not essential to determine the circumferential edge and/or circumferential surface for determining the at least one parameter. For instance, in the case of the spherical lens, the geometry of the edge of the spherical lens needs not to be determined for determining the optical thickness and in case of an aspherical lens one can furthermore determine the tilt between the surfaces from such a measurement wherein the geometry of the edge is not determined during the measurement. The optical thickness and tilt between the surfaces are parameters being indicative for the relative position of a first surface of an optical element with respect to a second surface of an optical element and used for determining the quality of the optical element.

It is then preferred that at least one of the plurality of second supports is movable, in at least a direction substantially perpendicular to the first direction, with respect to the other of the plurality of second supports. This enables to supporting device to hold optical elements of different sizes, while still being able to determine the circumferential edge and/or circumferential surface with respect to the first and/or second surface as is described above.

For a more accurate determination of the circumferential edge and/or circumferential surface, it is preferred that the contact surface of at least one second support of the plurality of second supports is arranged at a different position along the first direction when compared to at least one other second support of the plurality of second supports.

In a preferred embodiment, the contact surface of the supports, i.e. the first supports and/or second supports, is formed by a substantially spherical end of the supports. As the contact surfaces are given a substantially spherical, i.e. ball-shaped, form, contact points between the respective first or second surface that is supported on the supports and the supports can be more easily determined.

As the contact surface has a smooth three dimensional shape that is easily described in a mathematical equation, the contact points, i.e. the points of abutment between said first or second surface and the contact surface, can for instance be obtained by means of determining the points of intersection of the respective mathematical equation describing the surface shape of the contact surface and a mathematical representation of the surface shape of the first or second surface abutting said contact surface. It is noted that the contact surfaces may only be partially spherical, such that it is not required that they are fully spherically shaped.

Preferably, the plurality of first supports comprises three supports that are selectively movable with respect to each other along at least a direction substantially perpendicular to the first direction.

Hereby, the supporting device is arranged to more easily accommodate, and thereby provide a suitable supporting surface for, optical elements having different shapes and sized.

In a preferred embodiment, the supports are mutually spaced apart along an angular direction with respect to a central axis that is substantially parallel to the first direction. Hereby, the supports are arranged along a central section of the supporting device, such that a stable support is obtained for supporting optical elements that are to be measured.

It is preferred that the supporting device comprises a base plate and the supports are arranged on the base plate, wherein at least one of the supports is selectively movable in a radial direction with respect to a central axis of the base plate, wherein said central axis is substantially parallel to the first direction. The base plate comprising the supports provides for a stable and easily adjustable supporting device.

Preferably, the first supports comprise a first end that faces towards a central section of the supporting device and a second end facing away from the central section, wherein said contact surface is arranged at, or near, the first end. The obtained supports can hereby have a stable base, while still enabling the different supports to be arranged so close together that the contact surfaces of the respective supports are adjacent to each other and/or even contacting each other. This allows for even supporting very small optical elements that are to be measured. The at least one first support is arranged with the reference that is arranged near the second end of the first support. The reference can be used for determining the position (i.e. location) and/or orientation of the contact surface. By arranging the reference near, i.e. on an outer section of, the second end of the first support, the optical element can be positioned with respect to the first support in such a manner that the reference can still reached and/or measured by the measurement unit. This allows to map the surface shape of the respective surface facing the measurement unit, while also allowing to determine the position (i.e. location) and/or orientation of the contact surface without having to remove the optical element from the supporting device. This allows for a faster and easier method of mapping the respective surfaces.

It is further preferred that the reference comprises at least two spherical sections and/or the reference comprises at least two flat sections, wherein said first flat section is arranged at a non-zero angle with respect to said second flat section. It is noted that it is also possible to combine these any number of sections is a suitable manner, such that a reference can comprise two or more differently shaped sections (i.e. a flat section arranged with respect to a spherical section). These types of sections allow uniquely determining a position and orientation (of the contact surface) of the respective support.

In a preferred embodiment, the supports (e.g. first and/or second supports) comprise a plurality of measurement members comprising a contact surface arranged for contacting the optical element, wherein said contact surface of the measurement member is movable along at least a direction from and towards the optical element, and wherein each of the plurality of measurement members is arranged with a reference to uniquely define the position of the respective contact surface of the respective measurement member. Preferably, said supporting device comprises three first supports, as an object is thereby stably and uniquely supported by the supporting device. The references, that are arranged to be measured by the measurement unit, while an optical element is positioned on the respective supports, enable to uniquely determine the position and/or orientation of the contact surfaces of the respective (movable) measurement members. The movable measurement members thereby allow providing for additional contact points that can aid in obtaining the coordinate transformation from the measurement device coordinate system to the optical element coordinate systems, as has also been explained above. In addition, additional contact points are particularly helpful when dealing with optical elements having aspherical surfaces as these require more complex mathematical representations.

It is then preferred that said measurement members comprise a support base and a frame member, wherein said frame member is movable with respect to the support base. The support base can thereby be mounted to the supporting device, for instance to the base plate, while the movable frame member is arranged to enable the movement along at least the direction from and towards the optical element. The movable frame member can for instance be connected to the support base by means of a pivoting connection (e.g. a hinge connection) and/or an elastic and/or pliable connecting section.

Preferably, the contact surface of a measurement support is biased in the direction towards the optical element. Hereby, the contact surface is urged to contact the optical element, such that the contact points can be reliable obtained to aid in the determination of the coordinate transformation, as described above.

It is preferred that said plurality of measurement members comprises one or more first measurement members, wherein the respective contact surface is arranged at a first end of the first measurement members that faces the optical element and is arranged for abutting at least the other of the first and second surfaces, and wherein the respective contact surface is movable along at least the first direction; and wherein the reference is arranged at a second end of the respective first measurement member that extends in a direction away from the optical element. Such a structural arrangement allows for determining the contact points between the measurement members and the other of the first and second surfaces (as is also described above), as the reference is measurable by the measurement device such that the location and/or orientation of the respective contact surface is obtainable.

Preferably, said plurality of measurement members comprises one or more second measurement members, wherein the respective contact surface is arranged for abutting the circumferential edge and/or circumferential surface, and wherein the respective contact surface is movable along at least the second direction. The added amount of contact points that can be determined for the circumferential edge and/or circumferential surface of the optical element allows to also accurately determine the respective shape of the circumferential edge and/or circumferential surface, in particular for optical elements having a non-circular circumferential edge and/or circumferential surface.

In a preferred embodiment, the measurement unit comprises an optical probe for performing measurements for mapping said surfaces and references. Optical probes allows for contactless mapping, in a highly accurate manner, surfaces having complex shapes (i.e. geometries). Use of the optical probe thereby prevents contact, and thus possible scratching and/or other defects, of the high-performance optical elements.

In a second aspect, the invention relates to a method for determining one or more parameters being indicative for the relative position of a first surface of an object, in particular an optical element, such as a lens or mirror, a window or wafer, with respect to a second surface of the object, comprising the steps of:
providing a first data set comprising a geometry of a supporting surface and a geometry of one of the first and second surfaces with respect to the supporting surface that supports the other of the first and second surfaces;
providing a second data set comprising a geometry of a supporting surface and a geometry of the other of the first and second surfaces with respect to the supporting surface that supports the one of the first and second surfaces;
determining, on the basis of the geometry of the supporting surface from the first and second data set, the one or more parameters being indicative for the relative position of a first surface of the object with respect to a second surface of the object.

Such a method, for instance implemented on a computer, allows to obtain the geometry of the first surface of the optical element with respect to the second surface of the optical element, such that the one or more parameters being indicative for the relative position of a first surface of an optical element with respect to a second surface of the optical element can be obtained. As both surfaces are provided, e.g. by means of mapping with a measurement device according to the invention, with respect to a supporting surface whereon the other surface is supported, one can link the two data sets comprising the respective geometries. Note that the process has also been described in relation to the measurement system according to the invention. The method thus allows, for instance, determining one or more of a tilt between said front and back surfaces and a thickness along an optical axis of said lens, as is described in more detail below.

In a preferred embodiment, the method further comprises the steps of:
providing, in a measurement device comprising a measurement unit, a supporting device comprising the supporting surface for supporting the optical element in the measurement device in a first direction;
providing a geometry of the supporting surface;
receiving the optical element by the supporting device such that the other of the first and second surfaces abuts the supporting surface; and
wherein the step of providing the first data set comprises:
   mapping, using the measurement unit, the geometry of the one of the first and second surfaces of the optical element with respect to the supporting surface that supports the other of the first and second surfaces;
storing the geometry of the supporting surface and the mapped geometry of the one of the first and second surfaces as the first data set. These steps thus provide for a preferred method of providing the respective surface geometries.

It is further preferred that the method further comprises the steps of:
receiving the optical element by the supporting device such that the one of the first and second surfaces abuts the supporting surface; and wherein the step of providing the second data set comprises:
mapping, using the measurement unit, the geometry of the other of the first and second surfaces of the optical element with respect to the supporting surface that supports the one of the first and second surfaces;
storing the geometry of the supporting surface and the mapped geometry of the other of the first and second surfaces as the second data set.

Hereby, a preferred approach is enabled for obtaining the respective surface geometry, i.e. surface shape, by means of measurements using a suitable measuring device, such as the measurement device according to the first aspect of the invention. Hence, the method preferably also comprises the step of providing the geometry of the supporting surface comprises mapping the geometry of the supporting surface using the measurement unit.

In a preferred embodiment of the method, said one or more parameters are defined in an optical element coordinate system that is fixed with respect to the optical element; the respective surfaces are mapped, or provided, in a measurement device coordinate system that is fixed with respect to a measurement device; wherein the step of determining the one or more parameters comprises:
determining a coordinate transformation for transforming the geometries of the first and second surfaces from the measurement device coordinate system to the optical element coordinate system; and
determining said one or more parameters on the basis of the geometries of the first and second surfaces defined in the optical element coordinate system.

This enables a preferred approach wherein the one or more parameters can be efficiently obtained, in the optical element coordinate system, on the basis of geometries of surfaces that are provided in the measurement device coordinate system, as has been explained earlier.

The method preferably sequentially comprises the steps of: determining, based on the first and second data sets, contact points between the one of the first and second surfaces and the supporting surface, wherein said contact points correspond to locations on the one of the first and second surface where the supporting surface and the one of the first and second surface abut each other when the optical element is supported on supporting surface.

Determining the contact points allows for a preferred approach for determining a coordinate transformation for transforming the provided surface geometries of the respective first and second surface to the optical element coordinate system, as has been explained earlier. In this preferred embodiment, the contact points are determined in the optical element coordinate system and wherein the step of determining the one or more parameters comprises: determining the coordinate transformation on the basis of the determined contact points.

Preferably, the supporting device comprises a plurality of first supports comprising a contact surface for abutting the optical element and wherein said supporting surface is formed by said contact surfaces of the plurality of first supports. Hereby, the above described advantages are obtained.

Preferably, the at least one first support of the plurality of first supports is movable with respect to an other of the plurality of first supports, and wherein the method further comprises the step of: moving, in dependence of the size of the optical element, the at least one first support with respect to the other. This allows accommodating and stably supporting optical elements having different sizes, as is described above.

It is preferred that said optical element is a lens and said first surface is a front surface of the lens and the second surface is a back surface of the lens, and wherein said one or more parameters is one or more of a tilt between said front and back surfaces and a thickness along an optical axis of said lens. The optical thickness and tilt between the surfaces are used for determining the quality of the optical element, as was described in the introduction. The method thus allows for obtaining a indication of the quality of the lens on the basis of sequentially measured, or otherwise determined, surface shapes of the front and back surfaces of the lens.

It is preferred that the optical element further comprises a circumferential edge and/or circumferential surface, wherein the circumferential edge and/or circumferential surface interconnects said first and second surfaces of the optical element, and
wherein the first data set is further provided with a geometry of a secondary supporting surface for holding the optical element in a second direction different from the first direction,
wherein the secondary supporting surface abuts the circumferential edge and/or circumferential surface; and
wherein the second data set is further provided the geometry of the secondary supporting surface, wherein the secondary supporting surface abuts the circumferential edge and/or circumferential surface. This allows determining the first and/or second surface geometries with respect to the edge of the optical element, as is described above.

It is further preferred that the supporting device further comprise a plurality of second supports, wherein the second supports each comprise a contact surface, wherein the respective contact surfaces form the secondary supporting surface, and wherein at least one of the plurality of second supports is movable with respect to an other of the plurality of second supports, and wherein the method further comprises the step of: moving, in dependence of the size of the optical element, the at least one second support with respect to the other along the second direction, such that the circumferential edge and/or circumferential surface abuts the contact surfaces of the one and the other of the plurality of second supports. As the plurality of second supports are arranged to abut the circumferential edge and/or circumferential surface of the optical element at the contact surface that can be mapped by the measurement device, the circumferential edge and/or circumferential surface, even in case of a more complex geometry of said edge and/or surface, can be measured , at least at a number of discrete points corresponding to the contact surfaces of the second supports, as was described above.

Hereby it is preferred that the method further comprises the steps of:
mapping, prior to abutting said circumferential edge and/or circumferential surface, the contact surfaces of the plurality of second supports;
determining, after abutting said circumferential edge and/or circumferential surface, the position of the respective contact surfaces of the plurality of second supports. By mapping the contact surfaces of the second supports, the contact points with the circumferential edge and/or circumferential surface can be obtained in a similar manner as those of the first supports, as was described above.

Preferably, said optical element is a lens and wherein said first surface is a front surface of the lens and the second surface is a back surface of the lens, and wherein said one or more parameters is one or more of a tilt between said front and back surfaces, a thickness along an optical axis of said lens, a lens wedge and a lens decenter. The tilt between said front and back surfaces, a thickness along an optical axis of said lens, a lens wedge and a lens decenter are used for describing the optical properties of a freeform, or aspherical lens and are, as such, an indication of the quality of such a lens. The method thus allows for obtaining an indication of the quality of more complexed shaped (i.e. freeform and/aspherical) lenses on the basis of sequentially measured, or otherwise determined, surface shapes of the front and back surfaces of the lens.

It is furthermore noted that the measurement device and corresponding method are also suitable for determining one or more parameters being indicative for the relative position of a first surface of a general three-dimensional object with respect to a second surface of the general three-dimensional object.

The present invention is further illustrated by the following figures, which show preferred embodiments of the device and method. The figures are not intended to limit the scope of the invention in any way, wherein:

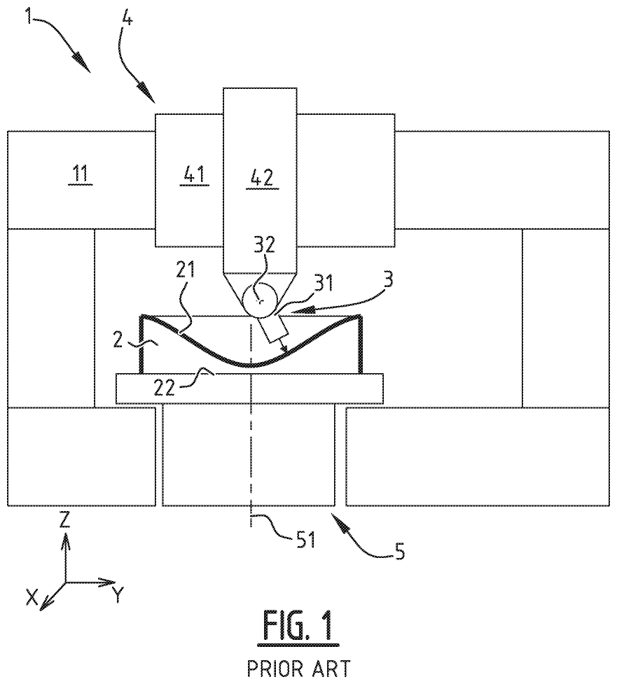

FIG. 1 schematically shows a measuring device according to the prior art;

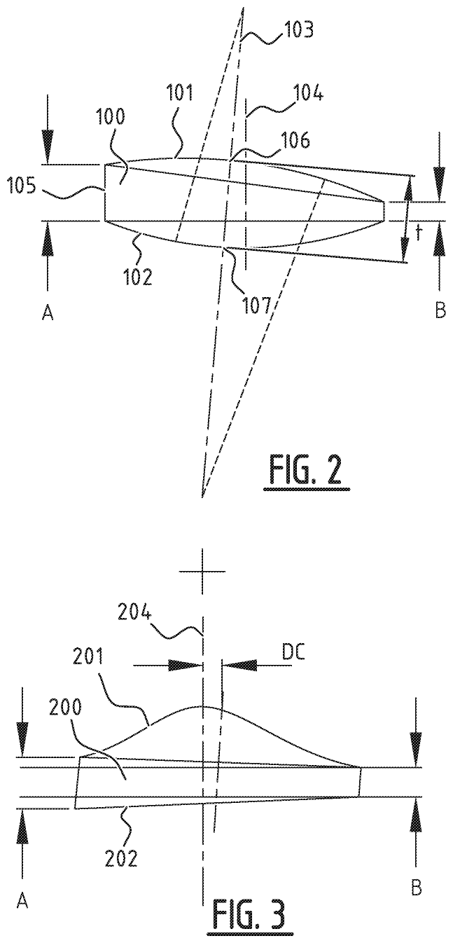

FIG. 2 schematically shows how to determine a first parameter, a wedge (i.e. total indicator reading: TIR), being indicative for the relative position of a first surface of lens with respect to a second surface of the lens;

FIG. 3 schematically shows an aspherical lens having a tilt and a decenter, which are parameters being indicative for the relative position of a first surface of an aspherical lens with respect to a second surface of the aspherical lens;

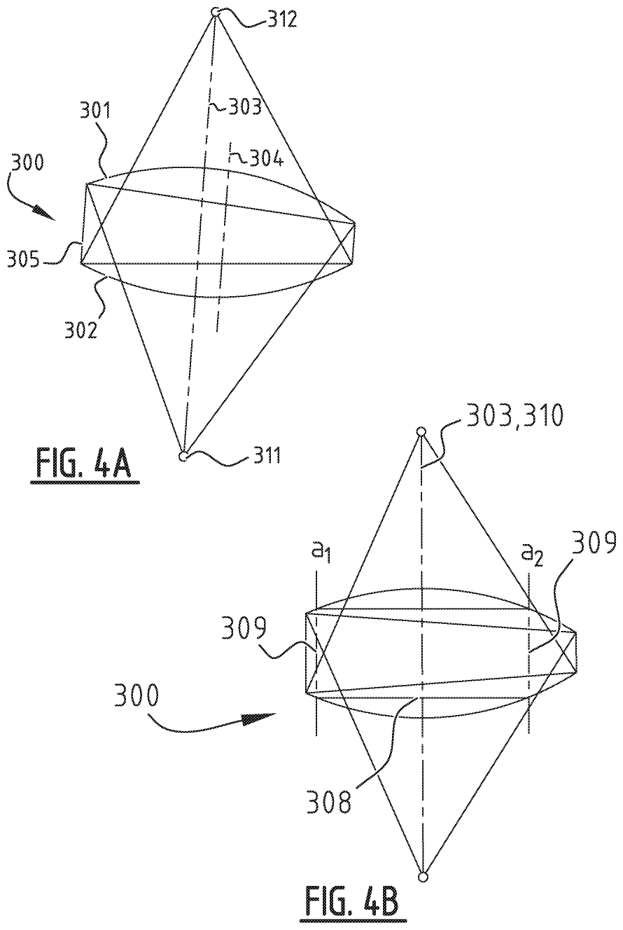

FIGS. 4A and 4B schematically show that the wedge and decenter are the same for a spherical lens;

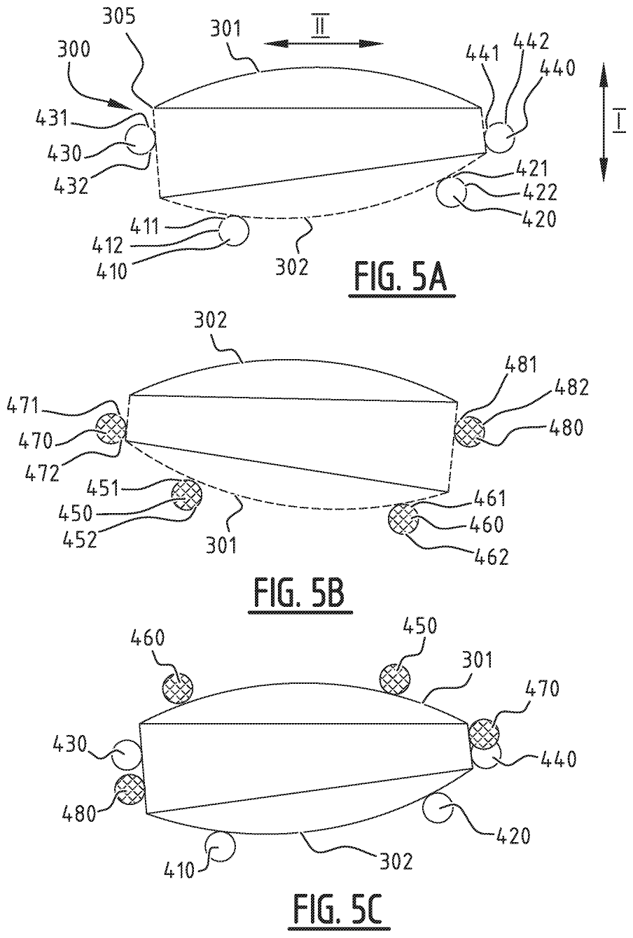

FIGS. 5A-5C schematically show the respective steps of an embodiment of the method according to the invention, wherein said steps can be executed using an embodiment of the measurement device according to the invention;

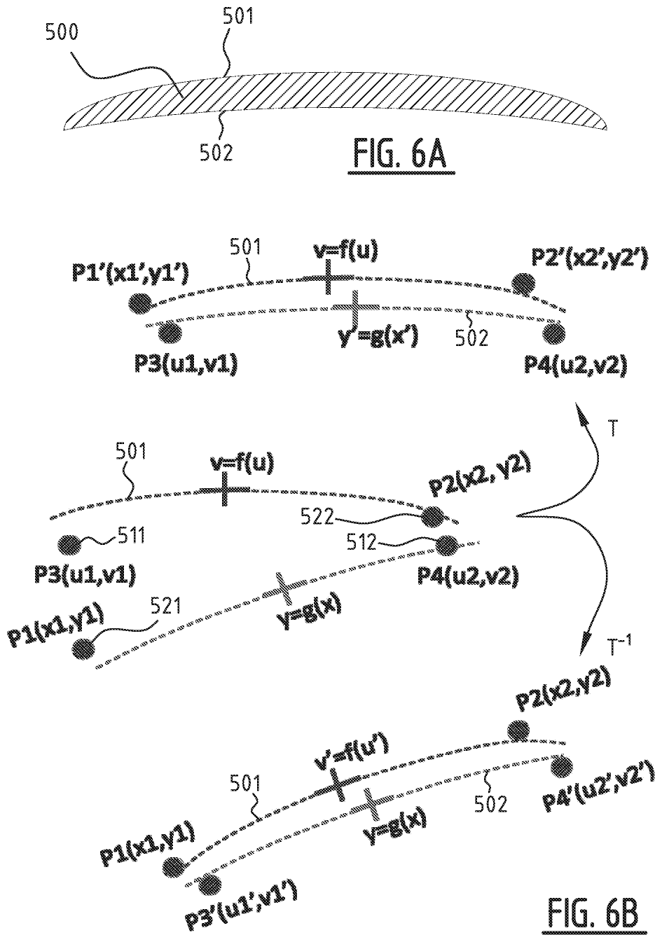

FIGS. 6A and 6B schematically shows an embodiment of a coordinate transformation for transforming the respective mapped surfaces of an optical element to an optical element coordinate system;

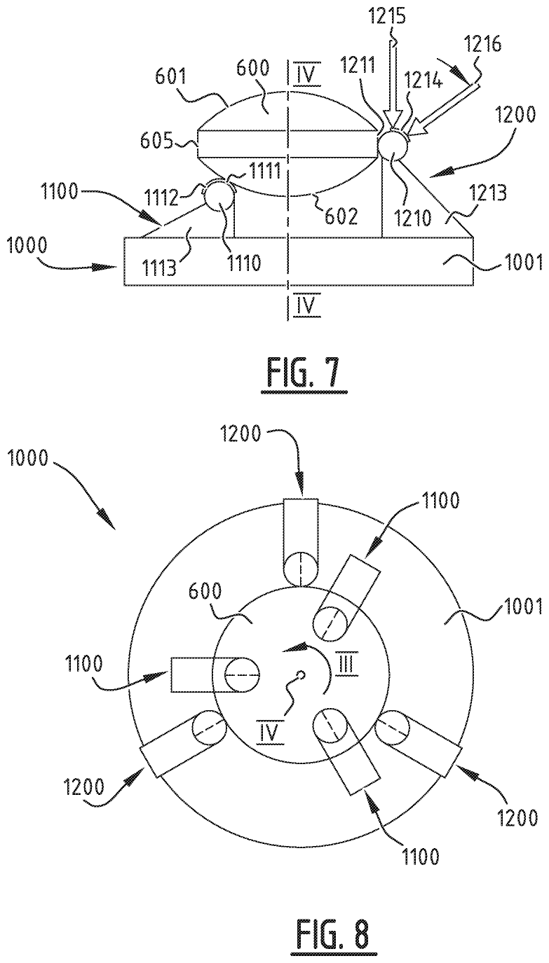

FIG. 7 schematically shows a partial side view of the lens that is supported in a supporting device of an embodiment of the measurement system;

FIG. 8 schematically shows a top view of the lens that is supported in the supporting device of the embodiment of the measurement system;

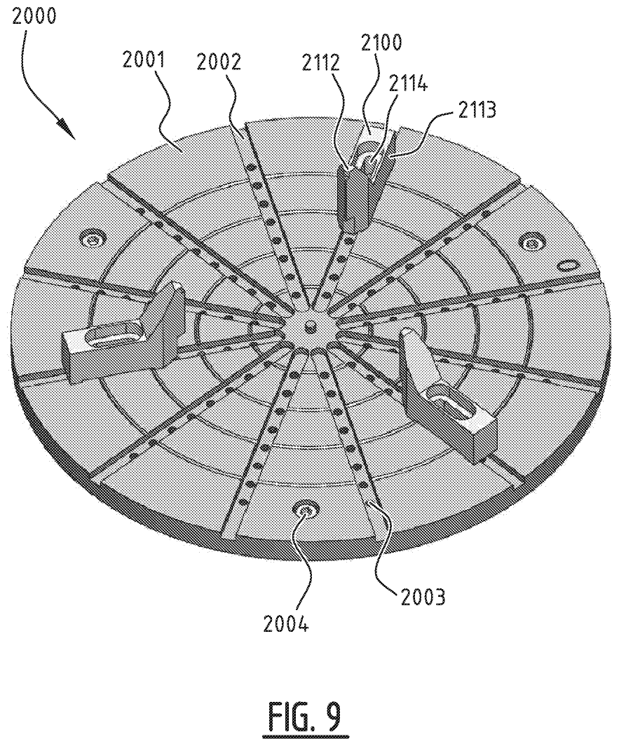

FIG. 9 schematically shows three dimensional perspective view of a supporting device of an embodiment of the measurement system;

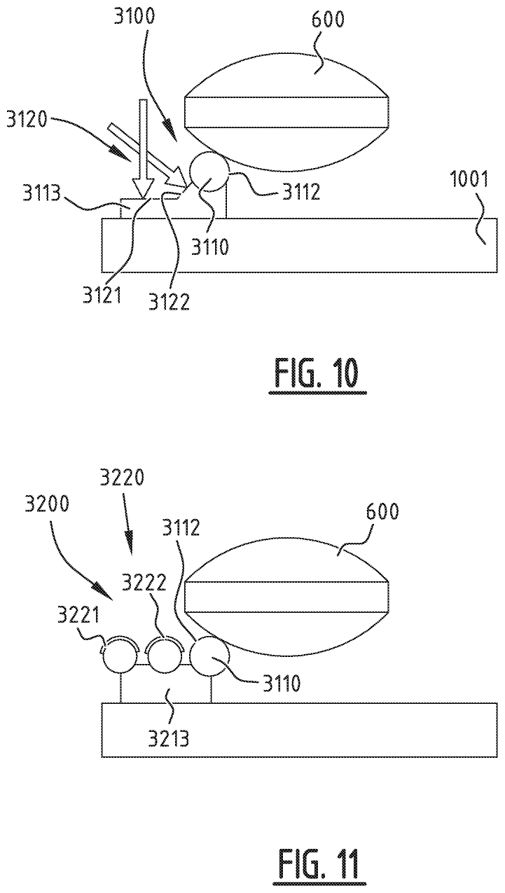

FIG. 10 schematically shows a partial side view of an embodiment of a first support comprising a first type of reference as is comprised in an embodiment of the measurement system;

FIG. 11 schematically shows a partial side view of a second embodiment of a first support comprising a second type of reference as is comprised in an embodiment of the measurement system;

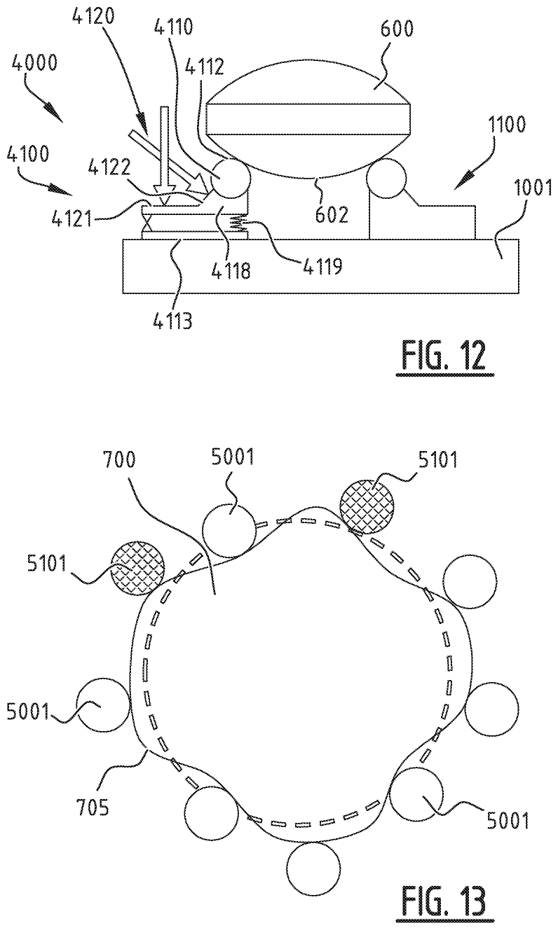

FIG. 12 schematically shows a partial side view of an embodiment of a supporting device comprising a first support and a measurement member as is comprised in an embodiment of the measurement system, and;

FIG. 13 schematically shows, in a top view, the use of a plurality of contact points, corresponding to a plurality of second supports, for mapping a circumferential edge and/or circumferential surface of non-circular optical elements.

FIG. 1 schematically shows a typical measuring device 1 for taking highly accurate measurements of surfaces 21 of three-dimensional objects 2 according to the prior art. Such a measurement device 1 is typically arranged with a measurement unit 3, comprising an optical probe 31, for scanning the surface 21. Said measurement unit 31 is connected to a (cartesian) moving system 4 through a pivoting servo mechanism 32 that allows to position the optical probe 31 substantially perpendicular to the first surface 21. The moving system 4 typically comprises a number of linear stages 41, 42 for moving the measurement unit 31 in the left-right, forward-backward and up-down directions (typically corresponding to the x, y and z coordinates of a cartesian system). The object 2 is, in the current example, supported on a rotational stage 5 (i.e. rotational moving system) for rotating the object 2 around a rotational axis 51 that is substantially parallel to the z-axis. Said rotational stage 5 comprises an object holder 52 for supporting (i.e. holding) the object 2 to be measured. The respective subsystems 4, 5 are connected to each other by means of a frame member 11 which is sufficiently stiff to ensure highly accurate measurements.

Such a device 1 is arranged to register a (plurality, i.e. more than three) measurement points taken by the optical probe 31 and the determine the corresponding location (i.e. position) of the surface 21 in the measurement device coordinate system by taking into account the position and/or angles of the stages 41, 42, 5 and servo mechanism 32, such that the corresponding location of the measurement point can be defined in the measurement system coordinate system. During the measurement, the relative positions of the surface 21 and the optical probe 31 vary, such that it is important to register the respective movements for generating a single consistent data set of measurement points taken for mapping the surface 21 of the object.

Hence, a single, isolated, surface 21 can be measured with a high resolution and accuracy using the existing optical probe measurement system 1. It is however often difficult, or even practically impossible, to accurately measure the opposing surface 22 on the other side of an object 2 with respect to the first surface 21, which is particularly important for an optical element, such as lenses. Measuring the second side 22 typically requires flipping the object in the measurement device, such that the other surface 22 is facing the optical probe 31 such that measurement can be taken. Due to flipping the object 2, a reference correlating the already measured surface 21 with the measurement device 1 is lost or cannot be accurately retained, such that one is not able to directly measure the second surface 22 with respect the first surface 21. A surface is thus mapped by taking a plurality of measurement points on the respective surface 21, 22, by enabling a relative movement of the respective surface 21, 22 and a measurement head, in particular the optical probe 31, along at least a direction substantially parallel to (a tangent plane of) the respective surface 21, 22, such that, at least as a raw data set, a (three-dimensional) point cloud, comprising a plurality (at least more than 3 for a line measurement) of measurement points (e.g. three dimensional coordinates), preferably a high number of measurement points (>20), is obtained that accurately represents the three-dimensional surface shape.

FIG. 2 schematically shows how to determine a first parameter, a wedge (i.e. total indicator reading: TIR), being indicative for the relative position of a first surface of lens 100 with respect to a second surface of the lens. If the axis 103 of a spherical lens 100 does not go through the center 104 of the edge 105 of the lens 100, the error is called wedge and is described as TIR (total indicator reading)=A−B. The thickness along the optical axis (t) is defined as the distance between the respective points 106, 107 where the optical axis intersects the respective first and second surfaces 101, 102. A lens 100 with wedge may still be aligned without error in an optical system, as the centers of curvature of the two surfaces 101, 102 can be placed on an axis of the optical system.

FIG. 3 schematically shows an aspherical lens having a tilt and a decenter (DC), which are parameters being indicative for the relative position of a first surface 201 of an aspherical lens 200 with respect to a second surface 202 of the aspherical lens 200. The surfaces 201, 202 are tilted with respect to each other, as is seen by the difference in thickness A and B in FIG. 3. The goal of aligning aspheric lenses having an aspherical and spherical surface (not shown) in an optical system is to position the axis of the aspheric surface, as well as a center of curvature of the second surface (not shown), on the axis of the optical system. This cannot be achieved if the center of curvature or the optical axis of the second surface does not coincide with that of the first. An attempt to center the lens will thus be a compromise between decentering and tilting one or both surfaces. As one needs to measure and correctively polish the lens, this would result in a reduced performance.

FIGS. 4A and 4B schematically show that the wedge and decenter are the same for a spherical lens 300. FIG. 4A shows a lens 300 having two spherical surfaces 301, 302 having respective sphere centers of curvature 311, 312 and an associated optical axis 303. The lens 300, as is seen due to the varying thickness of the circumferential surface 305, has a wedge, such that the axis 303 of the spherical lens 300 does not go through the center 304 of the edge 305 of the lens 300. However, as is seen in FIG. 4B, by cutting said lens along cutlines al and a2, an aspherical lens 308 is obtained, having a circumferential edge 309 having a substantially equal thickness along the circumference of lens 308. Hereby, the center 310 of the edge 309 of the lens 308 aligns with the optical axis 303, such that a perfect aspherical lens 308 is obtained having no wedge (and no decenter).

FIGS. 5A-5C schematically show different stages of the process for mapping the respective surfaces 301, 302 of the lens 300 in order to link the two individual measurements together, as visualized in FIG. 5C in order to define said first surface 301 with respect to the second surface 302. In FIG. 5A the lens is positioned on top of spherically shaped first supports 410, 420 each having a spherical, i.e. ball shaped, outer (i.e. contact) surface 412, 422. The combined contact surfaces 412, 422 of first supports 410, 420 thereby form the supporting surface for supporting the lens 300.

By mapping the respective contact surfaces 412, 422, for instance prior to position the lens 300 on top of the first supports 410, 420, the surface shape (i.e. geometry) of the contact surfaces 412, 422 is obtained in the measurement device coordinate system. Similarly, the second contact surfaces 432, 442 of the respective second supports 430, 440 can be measured. The second supports 430, 440 are arranged to abut the circumferential edge 305 of the lens 300, for instance, by moving the second supports 430, 440 towards the lens 300 until said second contact surfaces 432, 442 contact the circumferential edge 305. As the shape of the second contact surfaces 432, 442 is known, it is not needed to measure their full circumferences after abutting the circumferential edge. Rather, measuring only a part of the contact surfaces 432, 442 would then suffice to uniquely define the position of the second supports 430, 440 and thereby the second contact surfaces 432, 442 in the measurement device coordinate system.

The lens 300 is supported in the first direction I on the first supports 410, 420 on respective contact points 411, 421 at which the second surface 302 of the lens 300 abuts the respective contact surfaces 412, 422 and is constrained in at least a second direction II in a plane that is substantial orthogonal to the first direction I by the respective second supports 430, 440 as is described above. By measuring the first surface 301 of the lens 300, the first surface 301 is mapped (i.e. the three dimensional surface shape/geometry is measured) in the measurement device coordinate system, such that a first data set of mapped surfaces comprising a mapped first surface 301, mapped contact surfaces 412, 422 and mapped second contact surface 432, 442 is obtained, wherein these respective surfaces are known with respect to each other in the measurement device coordinate system.

In FIG. 5B, the lens 300 is turned over and repositioned on top of spherically shaped first supports 450, 460 each having a spherical, i.e. ball shaped, outer (i.e. contact) surface 452, 462. The combined contact surfaces 452, 462 of first supports 450, 460 thereby form the supporting surface for supporting the lens 300. Spherically shaped first supports 450, 460 may be identical (i.e. the exact same supports) and/or undisplaced (i.e. at the same position) with respect to spherically shaped first supports 410, 420. Spherically shaped first supports 450, 460 may also be different first supports, or may be displaced such that the first supports 410, 420 of FIG. 5A are displaced (i.e. repositioned). Spherically shaped second supports 470, 480 may be identical (i.e. the exact same supports) and/or undisplaced (i.e. at the same position) with respect to spherically shaped second supports 470, 480. Spherically shaped first supports 470, 480 may also be different second supports, or may be displaced such that the second supports 430, 440 of FIG. 5A are displaced (i.e. repositioned).

The first and second supports 450, 460, 470, 480 thereby support and constrain by abutting the first surface 301 at the respective contact points 451, 461, whereas the circumferential surface 305 is abutted by the respective contact points 471, 481 of the second supports 470, 480. By measuring the second surface 302 of the lens 300, the second surface 302 is mapped in the measurement device coordinate system (similarly as was done for the first surface 301 in FIG. 5A), such that a second data set of mapped surfaces comprising a mapped second surface 302, mapped contact surfaces 452, 462 and mapped second contact surface 472, 4842 is obtained, wherein these respective surfaces are known with respect to each other in the measurement device coordinate system.

FIG. 5C schematically represents the step of virtually overlaying the respective measured surfaces of the first and second data sets. It is seen that mapped surfaces 302, 452, 462, 472, 482 from the second data are turned over and positioned on top of the mapped surfaces 301, 412, 422, 432, 442 of the first data set. By a correct fitting of these data sets, on the basis of determining the contact points 411, 421 between mapped contact surfaces 412, 422 of the first data set and the mapped second surface 302 for the second data set and by determining the contact points 451, 461 between the mapped contact surfaces 452, 462 of the second data set and the mapped first surface 301 of the first data set.

The circumferential edge is not determined in case only the first supports 410, 420, 450, 460 are used in such a process. However, this still enables one to determine, as the one or more parameters, a tilt between said front and back surfaces and a thickness along an optical axis of said lens 300. By also taking into account the second supports 430, 440, 470, 480, the circumferential edge and/or circumferential surface 305 can also be determined, such that the furthermore allows for determining a lens wedge and a lens decenter. It is furthermore noted that the step of actually measuring (i.e. mapping) the surfaces 301, 302, 412, 422, 432, 442, 452, 462, 472, 482 is not essential for the method as the process could be performed on the basis of data sets comprising the surface geometries that are provided.

This process can, for instance, be performed visually, as is shown in FIG. 5A. However, said mapped surfaces 301, 302, 412, 422, 432, 442, 452, 462, 472, 482 can further be represented by a suitable mathematical representation, such as linear, (bi)cubic or spline interpolation methods, Inverse Distance Weighted (IDW) interpolation, Kriging interpolation and the like. This allows to perform the process by solving the associated mathematical problem, as is shown using the example of FIGS. 6A and 6B.

FIGS. 6A and 6B schematically shows a simplified two-dimensional embodiment of a coordinate transformation T, T⁻¹ for transforming the respective first and second mapped surfaces 501, 502 of an optical element 500 to an optical element coordinate system. It is noted that this process is similar in three dimension and would typically involve more variables and larger mathematical problems, which can however be solved in a similar manner. The process of mapping the respective surfaces 501, 502 is already explained in relation to FIGS. 5A and 5B. The first data set in this embodiment comprises the surface shape v=f(u) of the first surface 501 and the respective mapped supports 511, 512 being expressed by P3(u1,v1) and P4(u2,v2). The second data set in this embodiment comprises the surface shape y=g(x) of the first surface 502 and the respective mapped supports 521, 522 being expressed by P1(x1,y1) and P2(x2,y2).

The following conditions then apply:
Condition 0: f(u) and g(x) do not deform;
Condition 1: P1 . . . P2 should lie on a measured (known) part of f(u);
Condition 2: P3 . . . P4 should lie on a measured (known) part of g(x);
Condition 3: P1 . . . P4 should be independent points such that four independent equations exist.

Hereby the relative position of two surfaces 501, 502 can be determined, including thickness and relative tilt. Determining the wedge and decenter would however require data that defines the circumferential edge and/or surface of the optical element 500 however.

A coordinate transformation T can be defined for transforming y=g(x) to y′=g(x′), such that the second data set is transformed to coordinate system of the first date set. An coordinate transformation T⁻¹ (being the inverse of T) can be defined for transforming v=f(u) to v′=f(u′), such that the first data set is transformed to the coordinate system of the second data set. In both cases, the relative position of two surfaces 501, 502 can be determined.

Mathematically, this would work out to (wherein the third dimension is neglected, and noted as 1):

$$[ {x}^{′} , {y}^{′} , 1 ] = T [ x , y , 1 ] , with T = [ \begin{matrix}cos ( t ) & sin ( t ) & dx \\ - sin ( t ) & cos ( t ) & dy \\ 0 & 0 & 1\end{matrix} ] ,$$

Furthermore, as the optical element 501 assumed not to deform between measurements, or is assumed to be identical in both data sets, this would write:

[u′, v′, 1]=T⁻¹[u, v, 1]

Hence, P1 and P2 would give two independent equations for solving T, whereas P3 and P4 give two independent equations for solving V. For example, for P1 the independent equation is obtained by:

$$P {1}^{′} ∈ f ( u ) \text{=>} T [ x 1 , y 1 , 1 ] = [ u , f ( u ) , 1 ] \text{=>} \{ \begin{matrix}u = x 1 cos ( t ) + y 1 sin ( t ) + dx \\ v = - x 1 sin ( t ) + y 1 cos ( t ) + dy \\ v = f ( u )\end{matrix}$$

such that:

−x1sin(t)+y1cos(t)+dy=f(x1cos(t)+y1sin(t)+dx);

As f(u) and g(x) are known, T comprises independent variables (t, dx, dy) and the four support points P1,P2, P3, P4 give four independent equations, the coordinate transformation can be obtained as there are more independent equations than unknowns.

In three dimension, with three support points per data set, one would end up with six unknowns and six independent equations, such that a coordinate transformation T can also be obtained for the three dimensional case.

FIG. 7 schematically shows a partial side view of the lens 600 that is supported in a supporting device 1000 of an embodiment of the measurement system. The lens 600 is supported on the second surface 602 by a first support 1100. The first support 1100 comprises a spherical supporting member, or ball member, 1110 having a contact surface 1112 for abutting said second surface 602 at a contact point 1111. As was described above, part of the outer surface of the ball member 1110 is measured (or otherwise determined) for obtaining a mapped contact surface 1112. The ball member 1110 is connected to a base member 1113 of the first support 1100, which is in turn connected to a base support member 1001 of the supporting device 1000.

The second support 1200 is similarly constructed. The respective second ball member 1210 is arranged for abutting the circumferential edge and/or circumferential surface 605 of the lens 600, such that the edge of lens 600 can be determined, as is described above. As the geometry of the second ball member 1210 is known, it is only required to map a spherical section 1214 while the second ball member 1210 abuts the circumferential surface 605, to allow determining the respective contact point 1211 between the second ball member 1210 and the circumferential surface 605. The second ball member is connected, through second base member 1213 to the base support member 1001. It is preferred if the second support member 1213 is selectively movable with respect to the support member 1001, using for instance a releasable connection.

FIG. 8 schematically shows a top view of the lens 600 that is supported in the supporting device 1000 of the embodiment of the measurement system. The supporting device 1000 is seen to comprise a plurality of first and second supports 1100, 1200 that are spaced apart, as seen along an angular direction III around a central axis IV of the lens. The specific embodiment shows three first supports 1100 arranged substantial equally spaced at 120° angles with respect to each other and three first supports 1200 arranged substantial equally spaced at 120° angles with respect to each other. It is noted that the supports can also be arranged at different angles with respect to each other.

FIG. 9 schematically shows three dimensional perspective view of a supporting device 2000 of an embodiment of the measurement system. The supporting device 2000 comprises a base plate 2001 having a plurality of guide rails 2002, formed as longitudinal recesses running in a radial direction towards a centre of the base plate 2001. The guide rails 2002 are arranged for receiving a number of supports, such as first supports 2100, that can slide along the guide rails 2002 and can be locked in place using locking recesses 2003 that are arranged at different positions along the radial direction. The first supports 2100 are arranged with a designated contact surface 2112, that may be partially spherically shaped, may have any other known geometry or even be fitted with a ball member as shown in previous embodiments. The first supports 2100 may have a locking section 2114 arranged in the base member 2113 that is arranged for cooperation with the locking recesses 2003 of the base plate 2001, for instance be means of a lockable and releasable pin and/or bolt connection. The base plate 2001 can be mounted to a measurement device using the mounting holes 2004 that are arranged for receiving bolts or the like. It is noted that second supports (not shown) can be mounted in a similar manner. Such a supporting device 2000 allows to adjust the supports to match the object that is to be supported.

FIG. 10 schematically shows a partial side view of an embodiment of a first support 3100 comprising a first type of reference 3120 as is comprised in an embodiment of the measurement system. The first support 3100 comprises a ball member 3110 having a known shape (i.e. outer surface) of the contact surface 3112. The first support is fitted with a reference 3120 that allows for determining the orientation and/or positioning of the contact surface 3112 on the basis of the position and/or orientation of the first support 3100 that is determined by measuring (i.e. mapping) the respective reference 3120. The reference 3120 comprises for this purpose two flat reference surfaces 3121, 3122 that are arranged, preferably on the base member 3113, at a predefined angle with respect to each other. By mapping two flat reference surfaces 3121, 3122 the orientation and position of the first support 3100 can be determined, such that the position of the contact surface 3112 can also be determined.

FIG. 11 schematically shows a partial side view of a second embodiment of a first support 3200 comprising a second type of reference 3220. The function of reference 3220 is similar to the embodiment of FIG. 10. However, second reference 3220 comprises two ball-shaped reference surfaces 3221, 3222 that are arranged on a base member 3213 of the respective first support 3200. Again, on the basis of the measured ball-shaped reference surfaces 3221, 3222, one can, like above, determine the position of the contact surface 3112. It is noted that any type of reference can be applied, as long as it is possible to determine the position and/or orientation of the contact surface from measuring (i.e. mapping) the reference.

FIG. 12 schematically shows a partial side view of an embodiment of a supporting device 4000 comprising a first support 1100 and a measurement member 4100. The first support is equal to the first support shown in FIGS. 7 and 8. The measurement member 4100 comprises a contact surface 4112 for abutting the second surface 602 of the lens 600. The contact surface 4112 is, in the current example a spherical outer surface of ball member 4110, although other contact surface shapes are also applicable. The contact surface 4412 of the measurement member 4100 is movable along at least a direction from and towards the lens 600 and is arranged with a reference 4120 to uniquely define the position of the respective contact surface 4112 of the respective measurement member 4100.

The reference 4120 comprises in this embodiment two flat reference surfaces 3121, 3122 that are arranged, preferably on a movable frame member 4118, at a predefined angle with respect to each other. This reference is thus similar to the reference shown in FIG. 10. It is noted that any type of reference can be applied, as long as it is possible to determine the position and/or orientation of the contact surface from measuring (i.e. mapping) the reference. The reference of FIG. 11 can for instance also be applied.

To allow the movement, the movable frame member 4118 can for instance be connected by means of a pivoting connection to a base member 4113, which is in term (preferably releasably) connected to the base plate 1001. For urging the contact surface 4112 towards the lens 600, a biasing member 4119, such as an elastic member, spring member or the like, is arranged in between said base member 4113 and movable frame member 4118.

Such a measurement member allows for adding more points of contact to the measurement (and/or a data set of measurements). This allows to add more independent equations to the problem of FIG. 6 and helps to solve for the coordinate transformation. Even small measurement errors can cause the mathematical problem for solving the coordinate transformation when having the equal number of independent equations as unknowns. Hence, adding independent equations helps to obtain a more robust over dimensioned problem, that is solvable by, for instance, a least-squares approximation or similar mathematical techniques. If one would add more first supports 1100, this would cause supporting the object on more than three “legs” (like a four legged table on an uneven surface), such that it could wobble during the measurements and thereby render the measurements useless.

FIG. 13 schematically shows, in a top view, the use of a plurality of contact surfaces, corresponding to a plurality of second supports 5001, 5101, for mapping a circumferential edge and/or circumferential surface 705 of a non-circular optical element 700. By adding more second supports 5001, 5101 on can add more contact points, such that more complex shaped circumferences can also be mapped. Furthermore, by moving a number of second supports 5101 between measuring the first and second surface, one can achieve this effect without physically adding more supports.

A person of skill in the art would readily recognize that steps of various above-described method can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, flash drive, magnetic storage media such as a magnetic disks and magnetic tapes, hard drives, or optically readable digital data storage media. The embodiments are also intended to cover computers programmed to perform said steps of the above-described methods.

The steps of the method may be performed through the use of dedicated hardware as well as hardware capable of executing software such as firmware in association with appropriate software. When provided by a processor, the functions may be provided by a single dedicated processor, by a single shared processor, or by a plurality of individual processors, some of which may be shared. Moreover, explicit use of the term “unit”, “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included.

It is noted that the present invention is not limited to the embodiment shown, but extends also to other embodiments falling within the scope of the appended claims.

1-41. (canceled)

42. A measurement device for determining one or more parameters being indicative for the relative position of a first surface of an optical element with respect to a second surface of an optical element, the measurement device comprising:
a supporting device comprising a supporting surface for supporting the optical element in the measurement device in a first direction, wherein said supporting surface is arranged for abutting one of the first and second surfaces of the optical element;
a measurement unit arranged for simultaneously mapping a three dimensional surface shape of the other of the first and second surfaces of the optical element and for mapping a geometry of the supporting surface of the supporting device by taking measurements of the respective surfaces; and
a processing unit that is configured to determine the one or more parameters on the basis of a provided geometry of the one of the first and second surfaces, the mapped three dimensional surface shape of the other of the first and second surfaces and the mapped geometry of the supporting surface.

43. The measurement device according to claim 42, wherein the provided geometry of the one of the first and second surfaces is a mapped three dimensional surface shape of the one of the first and second surfaces, wherein said mapped three dimensional surface shape is mapped by taking measurement of the one of the first and second surfaces using the measurement unit.

44. The measurement device according to claim 42, wherein the processing unit is arranged to define an optical element coordinate system that is fixed with respect to the optical element and to define a measurement device coordinate system that is fixed with respect to the measurement device, wherein said measurement unit is arranged for mapping the respective surfaces in the measurement device coordinate system, wherein the processing unit is arranged for determining a coordinate transformation for transforming the geometries of the first and second surfaces from the measurement device coordinate system to the optical element coordinate system, and wherein the processing unit is arranged for determining said one or more parameters on the basis of the geometries of the first and second surfaces defined in the optical element coordinate system.

45. The measurement device according to claim 42, wherein the processing unit is configured to determine, based on the mapped geometry of the supporting surface and the geometry of one of the first and second surfaces of the optical element, contact points between the one of the first and second surfaces and the supporting surface, wherein said contact points correspond to locations on the one of the first and second surface where the supporting surface and the one of the first and second surface abut each other when the optical element is supported on supporting surface.

46. The measurement device according to claim 45, wherein the processing unit is arranged to define an optical element coordinate system that is fixed with respect to the optical element and to define a measurement device coordinate system that is fixed with respect to the measurement device, wherein said measurement unit is arranged for mapping the respective surfaces in the measurement device coordinate system, wherein the processing unit is arranged for determining a coordinate transformation for transforming the geometries of the first and second surfaces from the measurement device coordinate system to the optical element coordinate system, and wherein the processing unit is arranged for determining said one or more parameters on the basis of the geometries of the first and second surfaces defined in the optical element coordinate system, wherein said contact points are determined in the optical element coordinate system and wherein the processing unit is arranged for determining the coordinate transformation on the basis of the determined contact points.

47. The measurement device according to claim 42, wherein the supporting device comprises a plurality of spaced apart first supports, each comprising a contact surface for abutting the optical element, wherein said supporting surface is formed by said contact surfaces of the plurality of first supports, and wherein the plurality of first supports comprises three supports that are selectively movable with respect to each other along at least a direction substantially perpendicular to the first direction.

48. The measurement device according to claim 42, wherein at least one first support of the plurality of first supports is selectively movable with respect to the other of the plurality of first supports; and wherein the contact surface of the supports is formed by a substantially spherical end of the supports;
wherein at least one first support comprises a reference associated with a position of the respective contact surface of the respective at least one first support;
wherein the measurement unit is arranged for mapping a geometry of a reference of the at least one first support by taking measurements of the respective; and
wherein the a processing unit is configured to determine the position of the respective mapped contact surface of the respective at least one first support on the basis of the mapped geometry of the respective reference.

49. The measurement device according to claim 42, wherein the supporting device comprises a plurality of second supports for holding the optical element in a second direction different from the first direction, wherein the second supports each comprise a contact surface for abutting the a circumferential edge and/or circumferential surface of the optical element, wherein said circumferential edge and/or circumferential surface interconnects the first and second surfaces; and
wherein said measurement unit is arranged for mapping the contact surface of the plurality of second supports.

50. The measurement device according to claim 49, wherein at least one of the plurality of second supports is movable, in at least a direction substantially perpendicular to the first direction, with respect to the other of the plurality of second supports; and wherein the contact surface of at least one second support of the plurality of second supports is arranged at a different position along the first direction when compared to at least one other second support of the plurality of second support.

51. The measurement device according to claim 42, wherein the supports are mutually spaced apart along an angular direction with respect to a central axis that is substantially parallel to the first direction; wherein the supporting device comprises a base plate and the supports are arranged on the base plate; wherein at least one of the supports is selectively movable in a radial direction with respect to a central axis of the base plate, and wherein said central axis is substantially parallel to the first direction.

52. The measurement device according to claim 42, wherein at least one first support comprises a reference associated with a position of the respective contact surface of the respective at least one first support;
wherein the measurement unit is arranged for mapping a geometry of a reference of the at least one first support by taking measurements of the respective; and
wherein the processing unit is configured to determine the position of the respective mapped contact surface of the respective at least one first support on the basis of the mapped geometry of the respective reference;
wherein the first supports comprise a first end that faces towards a central section of the supporting device and a second end facing away from the central section, wherein said contact surface is arranged at, or near, the first end; wherein at least one first support is arranged with the reference that is arranged near the second end of the first support; wherein the reference comprises at least two spherical sections; and wherein the reference comprises at least two flat sections, wherein said first flat section is arranged at a non-zero angle with respect to said second flat section, wherein said supports comprise a plurality of measurement members comprising a contact surface arranged for contacting the optical element, wherein said contact surface of the measurement member is movable along at least a direction from and towards the optical element, and wherein each of the plurality of measurement members is arranged with a reference to uniquely define the position of the respective contact surface of the respective measurement member; wherein said measurement members comprise a support base and a frame member, wherein said frame member is movable with respect to the support base; and wherein said frame member comprises the contact surface and the reference; and
wherein the contact surface of a measurement support is biased in the direction towards the optical element.

53. The measurement device according to claim 52, wherein said plurality of measurement members comprises one or more first measurement members, wherein the respective contact surface is arranged at a first end of the first measurement members that faces the optical element and is arranged for abutting at least the other of the first and second surfaces, and wherein the respective contact surface is movable along at least the first direction; and wherein the reference is arranged at a second end of the respective first measurement member that extends in a direction away from the optical element,
wherein said plurality of measurement members comprises one or more second measurement members, wherein the respective contact surface is arranged for abutting the circumferential edge and/or circumferential surface, and wherein the respective contact surface is movable along at least the second direction; and wherein said measurement unit comprises an optical probe for performing measurements for mapping said surfaces and references.

54. A method for determining one or more parameters being indicative for the relative position of a first surface of an optical element with respect to a second surface of the optical element, comprising:
providing a first data set comprising a geometry of a supporting surface and a three dimensional surface shape of one of the first and second surfaces with respect to the supporting surface that supports the other of the first and second surfaces;
providing a second data set comprising a geometry of the supporting surface and a geometry of the other of the first and second surfaces with respect to the supporting surface that supports the one of the first and second surfaces; and
determining, on the basis of the geometry of the supporting surface from the first and second data set, the one or more parameters being indicative for the relative position of a first surface of an optical element with respect to a second surface of the optical element.

55. The method according to claim 54, further comprising:
providing, in a measurement device comprising a measurement unit, a supporting device comprising the supporting surface for supporting the optical element in the measurement device in a first direction;
providing a geometry of the supporting surface;
receiving the optical element by the supporting device such that the other of the first and second surfaces abuts the supporting surface; and
wherein the step of providing the first data set comprises:
mapping, using the measurement unit, the three dimensional surface shape of the one of the first and second surfaces of the optical element with respect to the supporting surface that supports the other of the first and second surfaces; and
storing the geometry of the supporting surface and the mapped geometry of the one of the first and second surfaces as the first data set.

56. The method according to claim 55, further comprising:
receiving the optical element by the supporting device such that the one of the first and second surfaces abuts the supporting surface; and
wherein the step of providing the second data set comprises:
mapping, using the measurement unit, the geometry of the other of the first and second surfaces of the optical element with respect to the supporting surface that supports the one of the first and second surfaces;
storing the geometry of the supporting surface and the mapped geometry of the other of the first and second surfaces as the second data set
wherein the step of providing the geometry of the supporting surface comprises mapping the geometry of the supporting surface using the measurement unit,
wherein said one or more parameters are defined in an optical element coordinate system that is fixed with respect to the optical element; the respective surfaces are mapped, or provided, in a measurement device coordinate system that is fixed with respect to a measurement device; wherein the step of determining the one or more parameters comprises:
determining a coordinate transformation for transforming the geometries of the first and second surfaces from the measurement device coordinate system to the optical element coordinate system; and
determining said one or more parameters on the basis of the geometries of the first and second surfaces defined in the optical element coordinate system.

57. The method according to claim 56, sequentially comprising the step of:
determining, based on the first and second data sets, contact points between the one of the first and second surfaces and the supporting surface, wherein said contact points correspond to locations on the one of the first and second surface where the supporting surface and the one of the first and second surface abut each other when the optical element is supported on supporting surface
wherein said contact points are determined in the optical element coordinate system and wherein the step of determining the one or more parameters comprises: determining the coordinate transformation on the basis of the determined contact points; wherein the supporting device comprises a plurality of first supports comprising a contact surface for abutting the optical element and wherein said supporting surface is formed by said contact surfaces of the plurality of first supports; and wherein at least one first support of the plurality of first supports is movable with respect to another of the plurality of first supports, and wherein the method further comprises the step of:
moving, in dependence of the size of the optical element, the at least one first support with respect to the other.

58. The method according to claim 54, wherein said optical element is a lens, wafer or mirror and said first surface is a front surface of the optical element and the second surface is a back surface of the optical element, and wherein said one or more parameters is one or more of a tilt between said front and back surfaces and a thickness along an optical axis of said optical element.

59. The method according to claim 54, wherein the optical element further comprises a circumferential edge and/or circumferential surface, wherein the circumferential edge and/or circumferential surface interconnects said first and second surfaces of the optical element,
wherein the first data set is further provided with a geometry of a secondary supporting surface for holding the optical element in a second direction different from the first direction, wherein the secondary supporting surface abuts the circumferential edge and/or circumferential surface; and
wherein the second data set is further provided the geometry of the secondary supporting surface, wherein the secondary supporting surface abuts the circumferential edge and/or circumferential surface.

60. The method according to claim 59, wherein the supporting device further comprise a plurality of second supports, wherein the second supports each comprise a contact surface, wherein the respective contact surfaces form the secondary supporting surface, and wherein at least one of the plurality of second supports is movable with respect to an other of the plurality of second supports, and wherein the method further comprises the step of:
moving, in dependence of the size of the optical element, the at least one second support with respect to the other along the second direction, such that the circumferential edge and/or circumferential surface abuts the contact surfaces of the one and the other of the plurality of second supports;
mapping, prior to abutting said circumferential edge and/or circumferential surface, the contact surfaces of the plurality of second supports; and
determining, after abutting said circumferential edge and/or circumferential surface, the position of the respective contact surfaces of the plurality of second supports;
wherein said optical element is a lens, wafer or window and wherein said first surface is a front surface of the optical element and the second surface is a back surface of the optical element, and wherein said one or more parameters is one or more of a tilt between said front and back surfaces, a thickness along an optical axis of said optical element, a lens wedge and a lens decenter.
